(19) United States
(12) Patent Application Publication
(10) Pub. No.: US 2005/0083251 A1
(43) Pub. Date: Apr. 21, 2005

(54) Plasma display panel with improved data structure

(76) Inventors: Yao-Ching Su, Taoyuan City (TW); Wen-Fa Sung, Hsinchu City (TW)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/687,921

(22) Filed: Oct. 20, 2003

(51) Int. Cl. G09G 3/28

(52) U.S. Cl. 345/60

(57) ABSTRACT

The present invention relates to a plasma display panel with barrier ribs configured in a closed shape. The panel has sub-pixel cells each with a cell area that is defined by the closed shape barrier ribs, sustain electrodes each spaced apart in a row direction at a predetermined cell length, and data electrodes each overlapping a barrier rib wall in a column direction and extending under the cell area. A plurality of the sub-pixels cells in a delta configuration defines a color pixel, whereby a dual scan gap of a predetermined gap length is formed between a pair of the data electrodes in the column direction, and a gap is formed between the row barrier ribs and data electrodes.

### BACKGROUND OF THE INVENTION

1. Field of the Invention

The present invention generally relates to improvements in a plasma display panel, and more particularly to an improved data structure in the plasma display panel forming a large luminance region. According the invention that data structure will to prevent discharge errors around dual scan gap area, that said dual scan gap area is interface area of between first and second group data electrode.

2. Related Art

Plasma display panels (PDPs) have become increasingly popular in the electronic industry. FIGS. 1a and 1b show a typical reflective type PDP. The PDP in FIG. 1a includes first and second substrates 10a and 10b in parallel, there are sequentially provided a plurality of sustain electrode pairs (scan, common electrode). The sustain electrode consisted of a transparent electrodes 12 is disposed on the first substrate 10a and extending along a row direction, and a bus electrodes 14 is disposed on the plural pairs of transparent electrodes 12 and extending along a row direction. A dielectric layer 16 is used to the cover the first substrate 10a, the transparent electrodes 12, and bus electrodes 14; and a protective layer made of MgO is used to cover the dielectric layer.

On the second substrate 10b, a plurality of address electrodes 18 parallel to each other are formed thereon and extending along a column direction that is orthogonal to the row direction. A plurality of barrier ribs 20 parallel to the plurality of data electrodes 18 are then formed on the second substrate 10b to define the discharge space. A plurality of fluorescent layers 22 are formed between the plurality of barrier ribs 20 for luminousness when the fluorescence layers 22 are radiated by ultraviolet light generated from gas in the discharge space.

Referring to FIG. 1b, each bus electrode 14 is completely adhered on each transparent electrode 12 . The area A is the bright region and the area B is the dark region.

The disadvantages of a conventional reflective PDP are evident in view of an stripe barrier rib construction as shown in FIGS. 2 and 3. Particularly, barrier ribs 20 as shown in FIG. 2 are aligned sequentially in a column and orthogonal to bus electrodes 14. Data electrodes 18, which are spaced regularly apart from each other in a direction parallel to the barrier ribs, are placed between the adjacent barrier ribs 22. A discharge (bright) area 26 occurs at the intersection between the data electrode and one of the RGB cells as defined by adjacent sustain electrodes and barrier ribs. A non-discharge (dark) area 27 occurs between the discharge areas, thereby forming a dual scan gap 28 between spaced apart data electrodes extending in a direction along the adjacent sustain electrodes. Transparent or indium-tin-oxide (ITO) part 12 of the sustain electrodes extends plasma when adequate voltage applied to the sustain electrode. Additionally, the discharge areas are not effectively utilized due to a dark area in conventional PDP.

Referring to FIG. 3, the dual can gap 28 formed between a first group of data electrodes 32 and second group of data electrodes 34

### SUMMARY OF THE INVENTION

Accordingly, the present invention has been made in consideration of the above disadvantages in the conventional reflective PDPs. One example of the present invention provides a plasma display panel with a triangular sub-pixel arrangement and a closed barrier rib structure defining a plurality of cell areas. Particularly, the panel includes sustain and data electrodes, wherein each sustain electrode is spaced apart in a row direction at a predetermined cell length from each other, and each data electrode overlaps a portion of the barrier ribs in a column direction and extends under each cell area. A ratio between a shift gap, which is formed between the row barrier ribs and data electrodes, and a dual scan gap, which is a predetermined gap length formed between a pair of data electrodes in the column direction, is also established to avoid discharge errors.

In another example, the present invention is directed to a method of constructing a plasma display panel with barrier ribs configured in a closed shape including the steps of configuring a plurality of sub-pixel cells each having a cell area by partitioning said barrier ribs, defining a color pixel through said sub-pixels cells in a delta configuration, disposing a plurality of sustain electrodes in a row direction and spaced apart at a predetermined cell length, and positioning a plurality of data electrodes to overlap with a wall of said barrier ribs in a column direction, wherein each of the data electrodes extend under the cell area, a dual scan gap of a predetermined gap length is formed between a pair of the data electrodes in a column direction, and a gap is formed between the row barrier ribs and data electrodes.

In yet another example, the present invention provides a plasma display panel with a construction that avoids discharge errors by increasing the overlapping area between the data electrode and sub-pixel, and establishing a maximum and minimum ratio between the discharge and dual scan gaps.

### DESCRIPTION OF THE DRAWINGS

The accompanying drawings, which are included to provide a further understanding of the present invention and are incorporated in and constitute a part of this specification, illustrate examples of the present invention and together with the description serve to explain the principles of the present invention. In the drawings:

FIGS. 1a and 1b illustrate a conventional plasma display panel with strip type barrier ribs;

FIG. 2 illustrates the construction of the conventional plasma display panel as shown in FIGS. 1a and 1b;

FIG. 3 illustrates a dual scan gap in the conventional plasma display panel;

FIG. 4a and 4b show an improved plasma display panel with a closed rib structure in polygonal or rectangular shape and a triangular sub-pixel arrangement in accordance with the present invention;

FIG. 5 shows the improved plasma display panel with data and sustain electrodes arranged in the closed rib structure of rectangular shape according to a first exemplary embodiment of present invention;

FIG. 6 shows the improved plasma display panel with data and sustain electrodes arranged in accordance with a second exemplary embodiment of the present invention;

FIG. 7 shows the improved plasma display panel with data and sustain electrodes arranged in accordance with a third exemplary embodiment of the present invention; and

FIG. 8 shows the improved plasma display panel with data and sustain electrodes arranged in accordance with a fourth exemplary embodiment of the present invention.

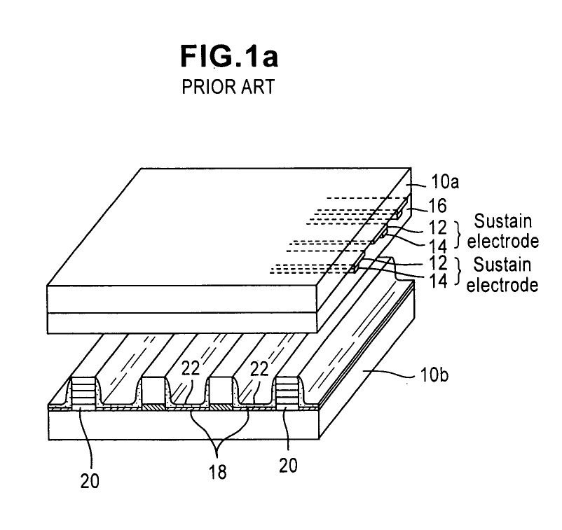

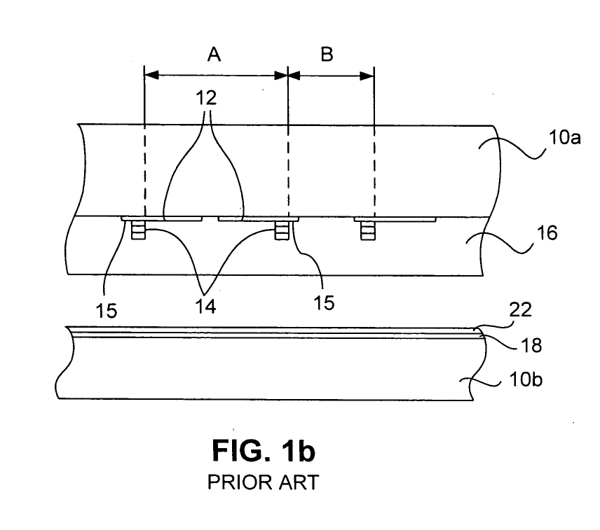

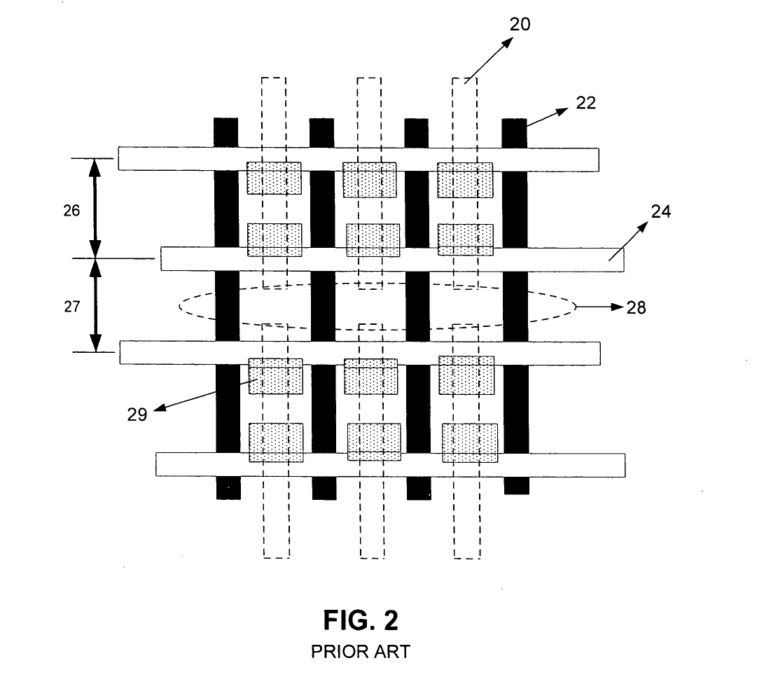

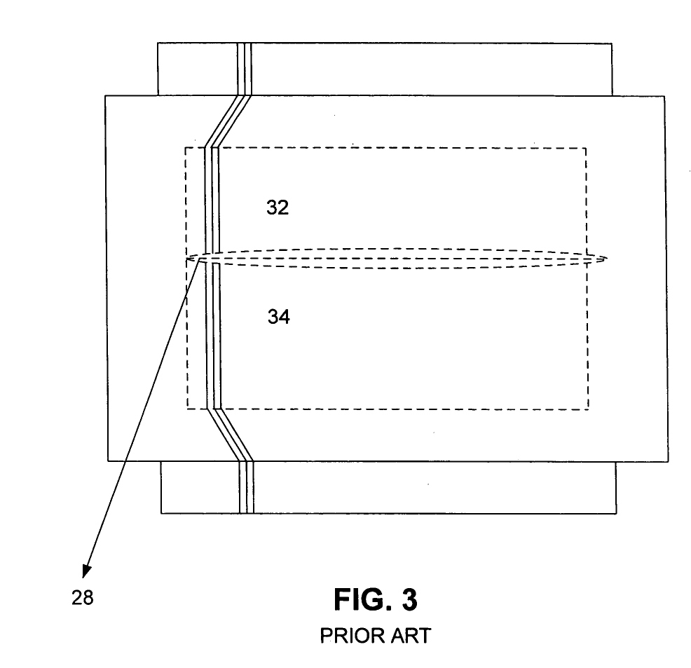

### DETAILED DESCRIPTION OF EXEMPLARY EMBODIMENTS

Reference will now be made in detail to the exemplary embodiment of the present invention, examples of which are illustrated in the accompanying drawings.

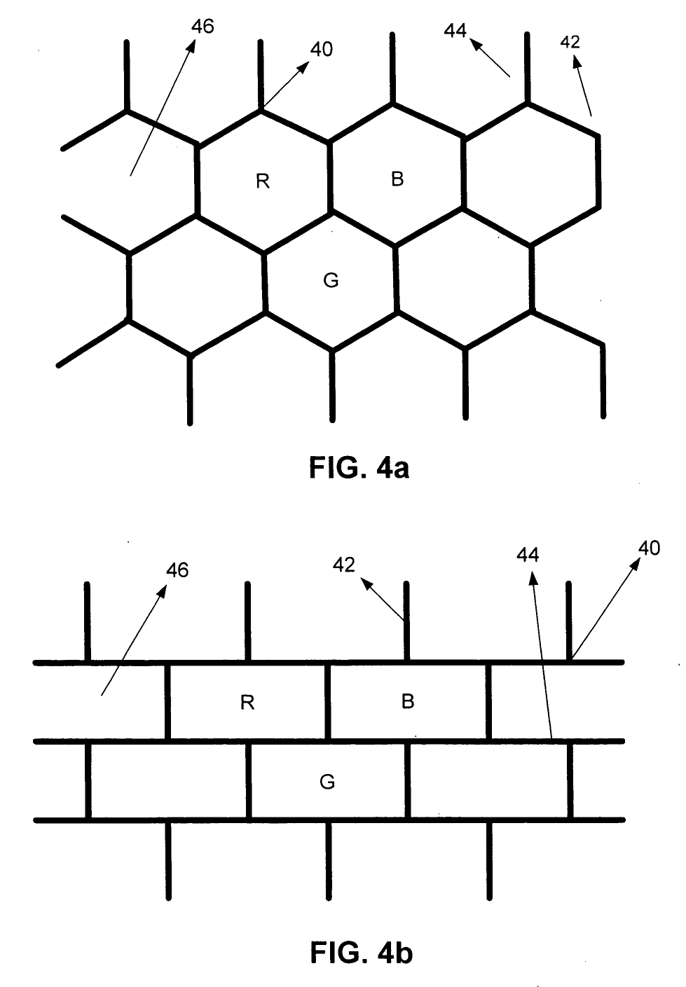

The present invention is directed to a plasma display panel which is constructed using a closed barrier rib structure and a triangular sub-pixel arrangement. As shown in FIGS. 4a and 4b, barrier ribs 40 can be divided into column barrier ribs 42 and row barrier ribs 44 and partitioned in a polygon or rectangular manner to define a plurality of sub-pixel cells 46 with red, green, and blue (RGB) phosphor layers disposed therein. Particularly, each sub-pixel cell 46 has a cell area which is defined by the column barrier ribs 42 intersecting the row barrier ribs 44. An RGB color pixel is formed by a group of red, green and blue sub-pixel cells 46 in a delta configuration. The combination of the RGB sub-pixel cells for each adjacent color pixels can be reversed in a sequential order. The closed barrier rib structure eliminates dark areas, and increases illumination efficiency according to increase phosphor area and open ratio. To avoid discharge errors in dual scan area according to various data electrode arrangements as discussed below.

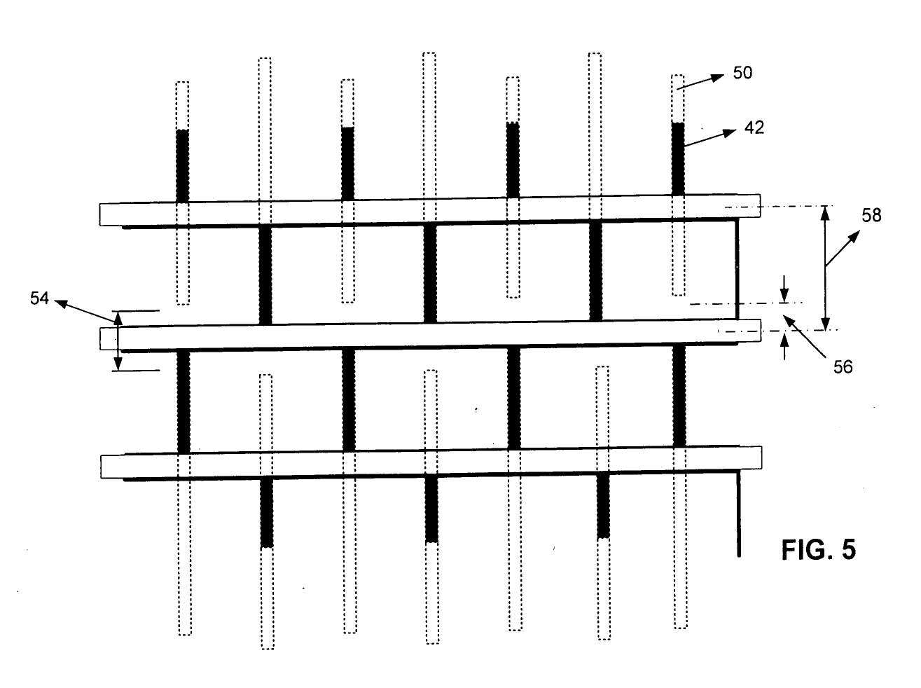

FIG. 5(a) illustrates one exemplary arrangement of the data electrodes in the improved PDP structure of the present invention. Particularly, the column barrier ribs 42 each aligned with a data electrode 50, and the row barrier ribs 44 are each aligned with a sustain electrode 52. The data electrode 50 is preferably of the same width as the column barrier rib 42, and extends under the sub-pixel cell. A dual scan gap (g) 54 is formed between a pair of the spaced part data electrodes 50, each overlapping with the column barrier rib 42 and partially extending on ends thereof under the sub-pixel cells 46. Such partial extension leaves a gap length (d) 56′, 56″ between one end of the data electrode and one of the row barrier ribs. To avoid image flickering at the dual scan area, the gap length 56′ is preferably less than 0.45p(positive value), where p is the cell pitch length 58 or distance between adjacent row barrier ribs 44 (i.e., d<0.45p). Additionally, to avoid addressing errors, the gap length 56 is preferably less than 40% (positive value), the gap length 56″ is negative value that also less than 0.45p. FIG. 5(b) illustrates another exemplary arrangement of the data electrodes in the improved PDP structure of the present invention. Such partial extension leaves a gap length (d) 56″ between one end of the data electrode and one of the row barrier ribs. Wherein that dual scan gap posited under barrier ribs.

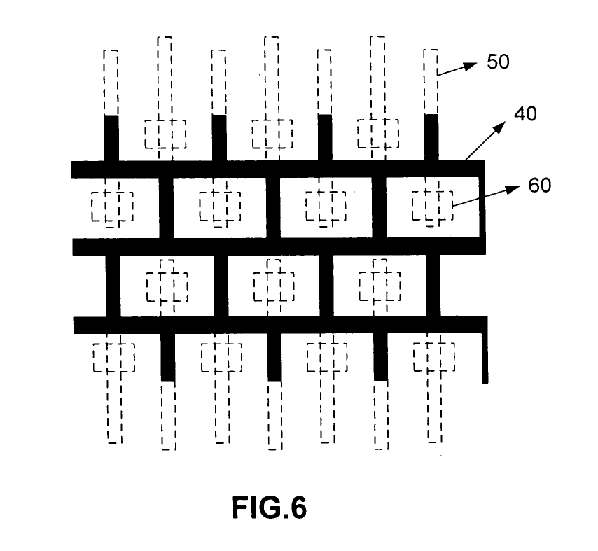

FIG. 6 illustrates a second exemplary embodiment of the plasma display panel according to the present invention. As show in FIG. 6(a), each data electrode may have varying width, depending on its positions in the cell region and the column ribs. Each data electrode has narrow width 50′ under column barrier ribs and enlarge width 50″ passing under the center portions of cell region. A portion of data electrode under cell region affect addressing ability, wherein that portion of data electrode positioned in dual scan area is designed to be larger than other cell in panel, as show in FIG. 6(b).

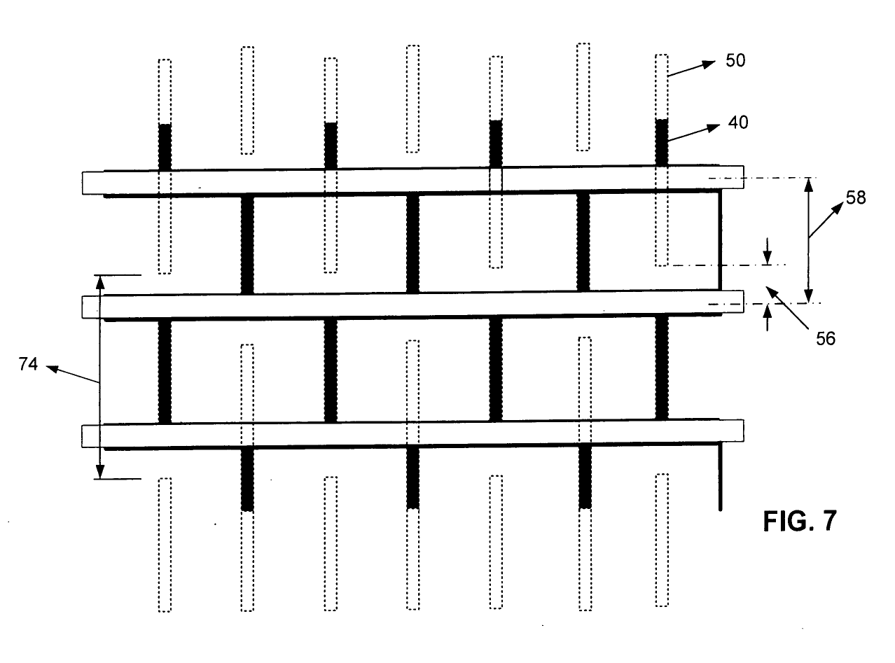

FIG. 7 illustrates a third exemplary embodiment of the plasma display panel according to the present invention. In this embodiment, a second dual scan gap is formed between adjacent data electrodes in the column direction. The second dual scan gap has a length that is greater than the cell pitch length 58 and extends over two of the row barrier ribs. To avoid image flickering, the ratio between the cell pitch length (p) and gap length (d) remains the same at less than 45% (i.e., d<0.45 p).

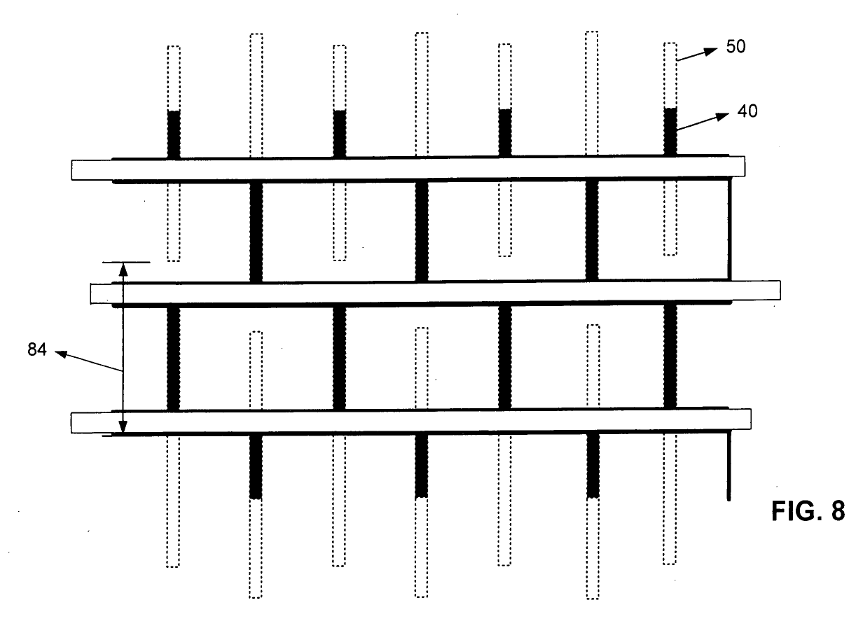

FIG. 8 illustrates a fourth exemplary embodiment of the plasma display panel according to the present invention. In this embodiment, a third dual scan gap is formed between adjacent data electrodes in the column direction. The third dual scan gap has a length that is greater than the cell pitch length 58 and extends over one of the row barrier ribs. To avoid image flickering, the ratio between the cell pitch length (p) and gap length (d) remains the same at less than 45% (i.e., d<0.45 p).

It will be apparent those skilled in the art that various modifications and variations can be made in the position encoded liquid crystal display device of the present invention without departing from the spirit or scope of the invention. Thus, it is intended that the present invention cover the modifications and variations of this invention provided they come within the scope of the appended claims and their equivalents.

1. A plasma display panel with barrier ribs configured in a closed shape comprising:
a plurality of sub-pixel cells each having a cell area defined by said closed shape barrier ribs;
a plurality of said sub-pixels cells in a delta configuration defining a color pixel;
a plurality of sustain electrodes each spaced apart in a row direction at a predetermined cell length;
a plurality of data electrodes overlapping a wall of said barrier ribs in a column direction, each of said data electrodes extending under said cell area., wherein
a dual scan gap of a predetermined gap length is formed between a pair of said data electrodes in the column direction, and
a gap is formed between said row barrier ribs and said data electrodes, and said gap is positive or negative.

2. The panel of claim 1, wherein said gap is less than 45% of said cell length.

3. The device of claim 1, at least one of wherein said gap is less than 40%.

4. The panel of claim 1, wherein said gap length is smaller than said cell length and said gap length crosses over one of said row barrier ribs.

5. The panel of claim 1, wherein said data electrodes has an expanded portion in said cell area.

6. The panel of claim 5, wherein said expanded portion is of a rectangular shape.

7. The panel of claim 1, wherein said gap length is greater than said cell length and said gap length crosses over one of said row barrier ribs.

8. The panel of claim 1, wherein said gap length is greater than said cell length and said gap length crosses over two of said row barrier ribs.

9. A plasma display panel with barrier ribs configured in a closed shape comprising:
a plurality of sub-pixel cells each having a cell area defined by said closed shape barrier ribs;
a plurality of said sub-pixels cells in a delta configuration defining a color pixel;
a plurality of bus electrodes each spaced apart in a row direction at a predetermined cell length;
a plurality of data electrodes overlapping a wall of said barrier ribs in a column direction, each of said data electrodes partially extending under said cell area., wherein
a dual scan gap of a predetermined gap length is formed between a pair of said data electrodes in a column direction, and
each of said gap length crosses over two of said row barrier ribs.

10. A method of constructing a plasma display panel with barrier ribs configured in a closed shape, said method comprising the steps of:
configuring a plurality of sub-pixel cells each having a cell area by partitioning said barrier ribs;
defining a color pixel through said sub-pixels cells in a delta configuration;
disposing a plurality of sustain electrodes in a row direction and spaced apart at a predetermined cell length;
positioning a plurality of data electrodes to overlap with a wall of said barrier ribs in a column direction, each of said data electrodes extending under said cell area., wherein
a dual scan gap of a predetermined gap length is formed between a pair of said data electrodes in a column direction, and
a gap is formed between said row barrier ribs and said data electrodes.

11. The method of claim 10, at least one of wherein said gap is less than 45% of said cell length.

12. The method of claim 10, at least one of wherein said discharge gap is less than 40%

13. The method of claim 10, wherein said gap length is smaller than said cell length and said gap length crosses over one of said row barrier ribs.

14. The method of claim 10, wherein said data electrodes have an expanded portion for additional coverage under said cell area.

15. The method of claim 10, at least one of wherein said gap length is greater than said cell length and said gap length crosses over one of said row barrier ribs.

16. A plasma display panel with barrier ribs configured in a closed shape comprising:
a plurality of sub-pixel cells each having a cell area defined by said closed shape barrier ribs;
a plurality of said sub-pixels cells in a delta configuration defining a color pixel;
a plurality of sustain electrodes each spaced apart in a row direction at a predetermined cell length;
a dual scan gap of a predetermined gap length is formed between a pair of said data electrodes in the column direction, and said dual scan gap under barrier ribs.
